(19) United States
(12) Patent Application Publication
(10) Pub. No.: US 2010/0224655 A1
(43) Pub. Date: Sep. 9, 2010

(54) ASSEMBLY FOR PACKAGING AND DISPENSING A COSMETIC PRODUCT

(75) Inventors: Marc Ramet, Argenteuil (FR); Vincent Riedinger, Bois D'Arcy (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'OREAL, Paris (FR)

(21) Appl. No.: 12/700,522

(22) Filed: Feb. 4, 2010

Related U.S. Application Data
(60) Provisional application No. 61/158,530, filed on Mar. 9, 2009.

(30) Foreign Application Priority Data
May 2, 2009 (FR) 09 50726

(51) Int. Cl. B67D 7/58; B65D 83/00

(52) U.S. Cl. 222/383.1; 222/402.13

(57) ABSTRACT

The present invention relates to a device for dispensing a cosmetic product, that includes a product dispensing member having a dispensing stem of longitudinal axis Z mounted movably in a body configured to be engaged through an aperture of a container, means for actuating the dispensing member, which can move the dispensing stem relative to the body, a dispensing orifice for dispensing product onto a body surface, a flexible product ejection tube connecting the dispensing stem to the dispensing orifice, in which the actuating means are configured to be actuated by squeezing both sides of a plane containing the longitudinal axis Z of the dispensing stem.

### CROSS REFERENCE TO RELATED APPLICATIONS

This document claims priority to French Application Number 09 50726, filed May 2, 2009 and U.S. Provisional Application No. 61/158,530, filed Mar. 9, 2009, the entire contents of each which are incorporated herein by reference.

### FIELD OF THE INVENTION

The present invention relates to an assembly for packaging and dispensing a cosmetic product, including a care product or a fragrance.

A preferred, but not exclusive, field of the present invention concerns the dispensing of a cosmetic product in fluid form by a dispensing member of pump or valve type.

### BACKGROUND OF THE INVENTION

### Discussion of Background

The term “cosmetic product” means a product as defined in Directive 93/35/EEC of the Council of 14 Jun. 1993.

Documents FR 2 649 955, FR 2 770 833, FR 2 857 945, FR 2 859 464, FR 2 888 569, FR 2 889 692, FR 2 891 475, FR 2 900 645, EP 0 557 714, EP 1 554 055, EP 1 183 194, US 2005/0 121 458 and US 2005/0 127 105 disclose examples of an assembly for packaging and dispensing a cosmetic product of the prior art.

Document FR 2 891 475 discloses a conditioning and dispensing assembly comprising a dispensing member of bulb type and a container. This bulb defines a flexible envelope housing a pump. This bulb extends outside the container and a distance therefrom. The bulb is maintained in fluid communication with the container by a flexible feed tube. This tube is maintained in the container by means of a stopper mounted in leaktight manner in the aperture of the container. A flexible ejection tube provided at the pump outlet is firmly held in an ejection head.

One drawback associated with such an assembly is that it is relatively bulky, especially in relation with the length of the feed tube. Furthermore, as it is made of a flexible material, the bulb, when placed in a handbag or a vanity case, may be accidentally actuated by the user. Moreover, such an assembly needs to be held in both hands when operated, one hand serving to grip the bulb, and the other to hold the container. In particular, given that the stopper is mounted by simple radial gripping in the aperture of the container, this stopper may have to withstand at least part of the weight of the bulb and of the dispensing member it contains, which may thus give rise to movement of the stopper, which is a source of leaktightness problems. In addition, such an assembly is complex to manufacture and has a high production cost.

Document EP 1 183 194 discloses a packaging and dispensing assembly comprising a case housing, on the one hand, a bottle provided with a neck equipped with a pump, and, on the other hand, means for actuating this pump. This pump comprises a hollow control stem that can slide in a pump body. The case comprises a transverse aperture that can receive a dispensing nozzle. A flexible tube connects the hollow stem to this nozzle. The means for actuating the pump comprise a toggle lever that can be actuated by manual pressing on a push button mounted through the case, which is arranged to force articulation of the toggle lever. By pressing in this way, the toggle lever is extended so as to move the hollow stem in the pump body, thus causing the product to be ejected via the flexible tube and dispensed through the nozzle.

However, one drawback associated with such an assembly is that it requires a substantial effort in order to actuate the dispensing of product. Furthermore, the actuating surface proves to be very limited and permits only actuation by the thumb, which is not very ergonomic for dispensing the product contained in the device on oneself.

Document US 2005/0 121 458 discloses a packaging and dispensing assembly comprising a dispensing member and a container mounted on a respective stage of a support. This dispensing member is provided outside the container, and is maintained in fluid communication with the container via a product feed tube.

However, one drawback associated with such an assembly is that it is particularly bulky. Specifically, this assembly needs to be mounted on a support of rack type. All the more so, such an assembly is not easy to carry around, for example in a handbag or a vanity case. Furthermore, this assembly is not easy to use. Moreover, such an assembly does not make it possible to orient the dispensed product at will towards a desired body surface.

### SUMMARY OF THE INVENTION

One aim of the present invention is thus to provide an assembly that overcomes at least one of the abovementioned drawbacks, i.e. associated with the overall bulk, and/or accidental actuation, and/or the ergonomics of use during the actuation of the dispensing member, and/or the leaktightness of the mounting of the dispensing member on the container, and/or the manufacturing cost of such an assembly.

An aim of the present invention may also be to provide an easily transportable travel assembly.

An aim of the present invention may also be to provide an assembly that is easy to manufacture, simple to use and of moderate production cost.

Another aim of the present invention may also be to provide an assembly that affords easy actuation the dispensing means without a substantial effort by the user.

Yet another aim of the present invention may be to provide an assembly that enables precise and, where appropriate, reproducible metering of the dispensed cosmetic product. In particular, an aim of this device may be to overcome the problems associated with conventional devices of bulb type in which the dispensing of product is dependent on the force exerted by the user on this bulb.

An aim of the present invention may also be to provide an assembly for which the dispensing of product may be oriented as the user desires.

An aim of the present invention may also be to provide an assembly that involves a novel operating gesture.

An aim of the present invention may also be to provide an assembly for dispensing the product contained in the container in the form of a fine spray.

An aim of the present invention may also be to provide an entirely leaktight assembly.

One subject of the present invention is thus a device for dispensing a cosmetic product, comprising:
a product dispensing member comprising a dispensing stem of longitudinal axis X movably mounted in a body intended to be engaged through an aperture of a container,
means for actuating the dispensing member, which can move the said dispensing stem relative to the body,
a dispensing orifice for dispensing product onto a body surface,
a flexible product ejection tube connecting the said dispensing stem to the dispensing orifice,

in which the actuating means are configured to be actuated by squeezing both sides of a plane containing the said longitudinal axis X of the dispensing stem.

This actuating characteristic allows the user to use his hand like a clip, thus making it possible to benefit from the maximum power to actuate the device. Such a device also affords great comfort of use for personal diffusion of product, for example on the neck.

The cosmetic product may be, for example, a fragrance, an antisun cream, a self-tanning product or a care product. The dispensing member may comprise a pump or a valve to be fixed by click-fastening, crimping, expanding or screwing onto a container neck. This container neck may define an aperture extending in the axis of elongation of the container. As a variant, this aperture may extend in an inclined general direction relative to this axis of elongation of the container. This direction of this axis may define an angle of less than or equal to 90°, 60°, 45° or 30°, or even 15° or less.

The dispensing orifice may be fixed relative to the container. In particular, this dispensing orifice may be firmly held facing or in a window of an ejection head.

The device may comprise a product feed tube for feeding product to the dispensing member, and a product ejection tube for feeding product to an ejection head, which is, where appropriate, equipped with a nozzle. These feed and ejection tubes may be flexible. These tubes may extend, respectively, upstream of an inlet clapper and downstream of an outlet clapper. The feed tube extends exclusively into the product container. This feed tube may be a dip tube connected to a sleeve coupling of the dispensing member.

The dispensing stem may be a pump or valve stem. This stem may be moved in leaktight sliding contact inside the said body, or optionally by pivoting in the case of a tipping valve.

The said actuating means may comprise a seating to be firmly mounted on a container comprising two mutually mobile actuating surfaces. These two surfaces are facing each other. They extend on either side of the plane containing the said longitudinal axis of the dispensing stem.

The said seating may comprise two opposite apertures blocked off with a respective plate, added where appropriate, each defining an actuating surface. In other words, these plates may thus be combined with a rigid frame. They may comprise a rigid wall, for example made of PP or of ABS, or a flexible elastic wall, for example made of an elastomeric material, for example SEBS or silicone.

The said actuating surfaces and more generally the said plates may be guided in movement relative to the said seating. In particular, these plates may be mutually mobile in translation relative to the said seating, especially one towards the other during movement from a resting state to an actuated state of the device, and one away from the other during movement from an actuated state to a resting state of the device.

The said actuating means may comprise at least one toggle lever system. This toggle lever system may be designed to be actuated by the said actuating surfaces. This device may comprise at least one toggle lever system extending in an inclined general direction relative to the axis of elongation of a container on which the said device is intended to be mounted.

The said actuating means may comprise several toggle lever systems. They may in particular comprise two toggle lever systems arranged in series. In such a case, the action of one consecutively brings about the action of the other for the purpose of the consecutive translational movement of the said dispensing stem.

These two toggle lever systems may extend in the deployed or extended position in two distinct general directions. The said two toggle lever systems may be deployed, respectively, in an inclined general direction relative to the dispensing stem and in a general direction that is substantially parallel to or coincident with the longitudinal axis of the dispensing stem. In particular, one toggle lever system may be at least partly axially offset relative to the dispensing stem, and the other may be at least partly facing the dispensing stem.

The actuating means may be forced in an actuating direction different from the direction of movement of the dispensing stem. In particular, the actuating means may be forced in an actuating direction substantially perpendicular to the said direction of movement of this stem.

The device may comprise a nozzle added in the said dispensing orifice, comprising a vortex duct system.

A subject of the present invention is also an assembly for packaging and dispensing a cosmetic product, comprising a device as defined previously combined with a container intended to contain a reserve of cosmetic product.

The actuating means may comprise at least one toggle lever system extending in an inclined general direction relative to an axis of elongation of the container.

The seating may be mounted outside the container, eccentrically relative to an axis of elongation of the container. In particular, the seating may comprise, in the mounted state of the device on the container, a centre of inertia located outside the container. This seating may be firmly oriented relative to the container.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particular since embodiments can be formed to practice the invention that do not include each of the features of the disclosed examples.

### BRIEF DESCRIPTION OF THE DRAWINGS

A better understanding of the invention will be gained from reading the following description in conjunction with the accompanying figures. The figures are offered purely as a guide and by way of example, and in no way limit the invention.

The invention may be understood more clearly on reading the detailed description that follows, made with reference to the accompanying drawings illustrating a non-limiting embodiment thereof, and in which:

FIG. 1 is an exploded elevated view in perspective of a first embodiment of a packaging and dispensing assembly according to the invention,

FIG. 2 is a mounted view in perspective of the assembly represented in FIG. 1,

FIG. 3 is a view in longitudinal cross-section of the assembly represented in FIG. 2,

FIG. 4 is an exploded view in perspective of a second embodiment of a packaging and dispensing assembly according to the invention,

FIG. 5 is a view in longitudinal cross section of the assembly represented in FIG. 4.

### DETAILED DESCRIPTION OF THE PREFERRED EMBODIMENTS

Referring now to the drawings, like reference numerals are utilized to designate identical or corresponding parts throughout the several views.

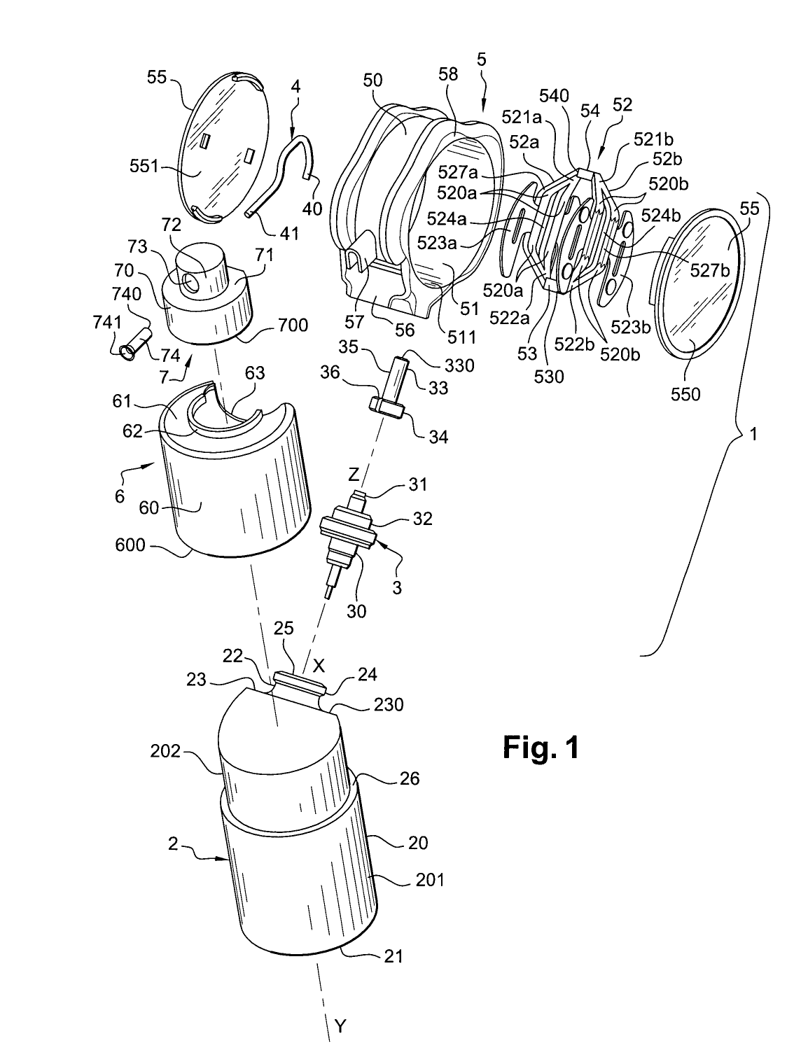

FIG. 1 represents a first embodiment of an assembly for packaging and dispensing a cosmetic or care product according to the invention.

This assembly comprises, on the one hand, a dispensing device 1 and, on the other hand, a container 2. The dispensing device 1 essentially comprises a dispensing member 3 and means 5 for actuating this member.

The container 2 may define an axis of elongation Y. This axis may be an axis of revolution. This container may comprise a side wall 20 comprising, on the one hand, a base 21 and, on the other hand, a dispensing neck 22. The dispensing neck may comprise a shoulder 23 from which extends a mouth 24.

This mouth 24 may rise from a bevel or chamfer 230 extending along an inclined plane relative to the axis of elongation Y of the container. The mouth 24 defines a mounting aperture 25 for the dispensing member 3. This mounting aperture may define an axis X secant, and especially orthogonal, to the plane of the bevel 230. The axis X may be inclined relative to the axis of elongation Y. This axis may, for example, be inclined by less than 90°, and in particular 60°, 45°, 30° or less, relative to the axis Y.

The side wall 20 may comprise a shoulder 26, which may be circular. This shoulder may separate two right cylinders, over at least a part of their height, of different cross sections 201, 202. The right cylinder 201 extending from the base 21 may have a larger diameter than the cylinder 202 provided with the aperture 25. In the example under consideration, the cylinder 202 is provided with the bevel 230 from which rises the said aperture 25.

The base 21 may comprise indexing means 210, the precise function of which will be explained later in the present description. These indexing means may, for example, comprise an imprint or a relief defining a given pattern. This pattern may be of non-circular shape.

The actuating means 5 are intended to be added firmly to the container 2. To do this, these means may optionally be mounted by means of a mounting hoop 6 that is added or integrated as one piece.

The hoop 6 may comprise a side skirt 60 comprising a lower end 600 defining an aperture for mounting onto the neck 22 of the container 2. At the opposite side, the hoop 6 may comprise a shoulder 61 defining a neck 62. This neck 62 may optionally be equipped with means for attaching a cap 7.

This hoop may comprise a cutaway 63. Such a cutaway may be provided on the side wall 60. It may extend onto the shoulder 61 or even the neck 62.

The device 1 may also comprise a cap 7 intended to overhang the hoop 6. This cap may comprise a peripheral skirt 70 comprising an open lower end 700 for mounting it on the hoop. This peripheral skirt may optionally comprise an inner recess 71 from which rises a product ejection head 72.

This ejection head 72 may comprise a transverse window 73 intended to define or firmly receive a dispensing orifice. Such a window may be provided laterally on this head. In other words, it may extend transversely to the axis of elongation Y of the container. This window may receive a product ejection nozzle 74, for example mounted on the outside of the said head. This nozzle may comprise a product ejection duct 740 opening onto a nozzle cone 741 defining a product dispensing orifice. Such a nozzle cone may be made as one piece with the said nozzle or added onto this nozzle. This nozzle cone may comprise a system for vortexing the product to be distributed opening onto the said orifice. It may be received firmly in the window.

This ejection head may comprise a passage 75 optionally provided with click-fastening means 750, the function of which will be explained later in the present description.

The dispensing member 3 may comprise a pump or a valve intended to take up in the container 2 a measured or non-measured amount of cosmetic product to be dispensed. This dispensing member may thus define a chamber for metering out the product to be distributed, where appropriate equipped with an inlet clapper and an outlet clapper (not shown).

This dispensing member 3 may be attached through the aperture 25 of the container via any suitable means, where appropriate permanently. In particular, this dispensing member may be attached to the container via a fixing ring 32 to be click-fastened, crimped, expanded or screwed around the neck of the container. Such a member may be engaged through the aperture 25 of the mouth 24 of the container so as to be firmly oriented relative to the container. In other words, in the mounted position, this member may be only movable axially along the axis X of the aperture 25.

The dispensing member 3 may comprise a body 30 to be engaged in the mouth 24 of the container. This body may then extend through the aperture 25 of the container. This body may define on the inside a sliding surface for a hollow dispensing stem 31. More precisely, this stem may comprise a sealing lip that can move in leaktight sliding contact inside the said body 30 for the purpose of dispensing product. The dispensing stem 31 defines on the inside a product dispensing duct. This stem may then be moved against the said body so as to vary the volume of the metering chamber for the purpose of expelling product through it. This stem may be securely fastened to return means housed in the body 30, and optionally in the metering chamber.

This body may also comprise sleeve for coupling to a dip tube. This dip tube then forms a tube for feeding product to the dispensing member 3. This tube then extends exclusively into the container.

The device 1 may also comprise a tip 33. This tip may be configured to cover the dispensing member 3. More precisely, this tip may be configured to cap the dispensing stem 31.

In particular, this tip 33 may comprise a sleeve 34 for connecting to the dispensing stem 31. It may optionally comprise a channel 35 rising from this sleeve. The sleeve 34 may be connected to the channel 35 via an internal recess 36. The channel 35 may be provided on the inside with a constriction 331. This constriction may be provided upstream of a free end 330.

The actuating means 5 of the dispensing member 3 comprise a seating 50, for example in the form of a drum. This seating may form a rigid, non-deformable frame. This seating may comprise a transverse aperture defining a housing 51. This housing may define an inner surface 511, which may be cylindrical. It may in particular have the general configuration of a right cylinder. The seating 50 may be made as one piece.

The housing 51 may be designed to receive force transmission means 52, the function of which will be explained later in the present description.

These force transmission means 52 may comprise a toggle lever system. This toggle lever system may be made as one piece, especially of a polyacetal such as POM or a polyolefin such as PP. This system may in particular comprise two toggle lever devices 52a, 52b arranged facing each other. Each device may comprise two toggle levers. Each toggle lever may comprise an arch. This arch may be generally U-shaped.

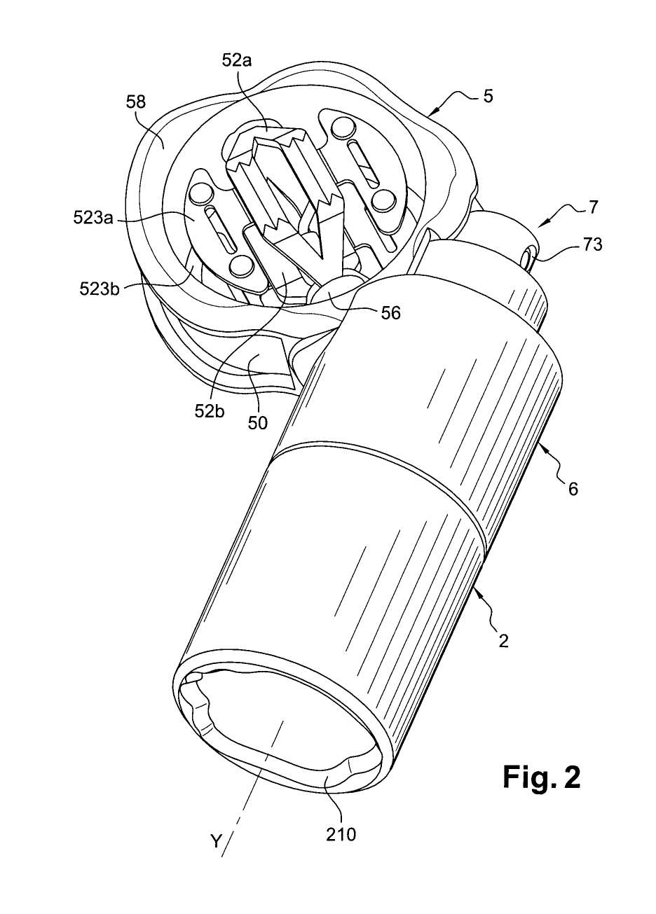

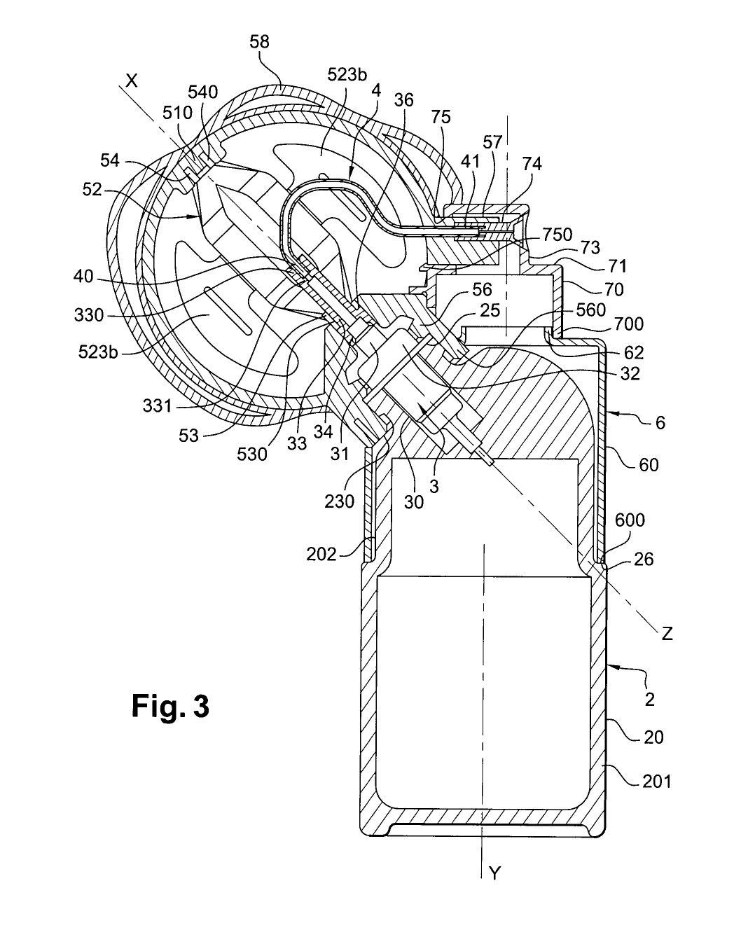

In the example illustrated in FIGS. 1 to 3, each device 52a, 52b comprises two arches 521a, 521b. Each arch may comprise a plurality of transmission arms connected by one or more preferential deformation portion(s) referred to in the rest of the present description as hinge(s). In this example, this arch may comprise three articulated force transmission arms 527a, 527b, two end arms being provided on either side of a central arm. The central arm may be articulated relative to the end arms by means of a respective hinge 520a, 520b. Such hinges may be film hinges or pin hinges.

The end arms of one arch of a device may be connected to the respective end arms of the other arch of this same device. The end arms may thus join up in an opposite respective common part 522a, 522b, one common part of a device being separated from the other common part of this same device by a slit 524a, 524b. In other words, the central arm may be split in two, or even more, in order to broaden the available actuating surface.

Each device may comprise on either side force-spreading means or reinforcing means 523a, 523b aimed at further stabilizing the said system when a load is applied thereto. These reinforcing means may comprise ribs. In particular, such ribs may extend, where appropriate radially, from a respective outer edge of the arches 521a, 521b, and in particular from an outer edge of the central arms.

Each device may be connected to the other by a brace 53, 54. These braces may connect together the respective common parts 522a, 522b of the arches of each device. This system may define a plane of symmetry passing through these braces.

This system may comprise means 540 for fixing to the seating 50. More precisely, the brace 54 may comprise means for fixing to the seating 50. These fixing means may comprise a socket configured to be mounted by any suitable means on the seating. More precisely, this socket 540 may define a blind bore or through-bore that can be fitted tightly into or around a protuberance 510 of the seating 50. These fixing means may firmly anchor the force transmission means to the seating 50. Such fixing means may then serve as a fixed bearing point for these force transmission means when a load is applied thereto.

This system may comprise means 530 for coupling to the dispensing member 3. In particular, these coupling means may be used to securely fasten the force transmission means 52 to the dispensing stem 31 during movement.

More precisely, the brace 53 may support the said means 530 for coupling to the tip 33. These coupling means may comprise a socket configured to be mounted by any suitable fixing means onto the tip 33, such as by tight fitting.

The toggle lever devices 52a, 52b are rotatably articulated relative to the fixing means 540 and to the coupling means 530 by a respective hinge. Such hinges may thus be provided between the fixing means and the coupling means and the respective common parts 522a, 522b.

As a variant, the force transmission means may comprise a toggle lever system including one or more elastically deformable blades (not shown), for example at least partly made of an elastically deformable material, for example elastomer, for example vulcanized, silicone, nitrile, butyl, EPDM, thermoplastic elastomer, SIS (styrene-isoprene-styrene), SEAS, Hytrel®, Pebax®, PE, PET, PA, PVC, PS or a polyolefin such as PP or a polyacetal such as POM. These blades may have a curved profile. In particular, they may be arranged facing each other and have an inverse curvature relative to each other. These blades may be connected together by rigid braces.

The seating 50 may comprise a reinforcing ring 56. This ring may comprise a sleeve defining on the inside a transverse aperture 564. This sleeve may comprise a drum 261 of cylindrical surface, the function of which will be explained later in the present description. This aperture may be oriented perpendicular to the transverse aperture of the housing 51. Such an aperture may be partly located at the front of the seating 50.

The ring 56 may be provided on the inside with reversible fixing means 560. Such fixing means may, for example, comprise click-fastening means.

This seating 50 may also comprise a snout 57. This snout may be located at the front of the seating, especially above the reinforcing ring 56. This snout may make the housing 51 of the seating communicate with the exterior. In order to connect the seating 50 to the cap 70, the snout 57 is housed in the passage 75 of the ejection head 72. This snout may optionally be held in this passage by the click-fastening means 750. As a variant, it may, for example, be held by tight fitting in this passage.

The device 1 also comprises a flexible product ejection tube 4. This tube may be of constant diameter. It may connect the dispensing member 3 to the cap 70. In particular, the flexible tube may connect the tip 33 to the ejection head 72. More precisely, this flexible tube may comprise a first end 40 that connects to the free end 330 of the channel 33 and a second end 41 mounted on the nozzle 74. This second end may, for example, be firmly received in the nozzle 74 engaged through the window 73. The constriction 331 of the channel may be of the same cross section as that of the tube.

To position this tube 4, the tip 3 equipped with the flexible tube 4 is positioned through the aperture of the reinforcing ring 56. This tip 3 is connected to the socket 530 of the force transmission means 52. To do this, this socket must engage tightly around the channel 35. In the final mounted position, this socket may optionally come to rest against the recess 36. The flexible tube 4 is then placed through the snout 57 in order to be firmly connected to the nozzle 74. In the final mounted position, this flexible tube 4 may extend at least partly into the housing 51 of the seating.

The housing 51 of the seating is then closed off on either side by an actuating member 55. This actuating member may comprise two plates each closing off a respective aperture of the housing 51 of the seating. These plates may be distinct and added in their respective aperture. These plates may be rigid and non-deformable. They may have a general disk configuration. These plates comprise an outer surface 550 and an inner surface 551.

Such plates may pass one or more click-fastening notches in order to position them in the said housing. In the mounted position, these plates may extend in a mutually parallel respective plane. Such plates may extend facing each other on either side of the toggle lever system 52.

It should be noted that, as a variant, the plates 55 may comprise an elastically deformable member, such as foam or a flexible plate, for example made of elastomer.

The actuating means 5, the tip 33, the flexible tube 4 and the cap 70, optionally equipped with a nozzle, may form a unit assembly that may be referred to as a push-button to be combined with the product container 2 in order to form a packaging and dispensing assembly.

Such an assembly may be assembled in the following manner.

First, the hoop 6 may be mounted on the container 2. More precisely, the hoop 6 may be mounted around the container 2. In particular, the side skirt 60 may be positioned, where appropriate by tight fitting, around the side wall 202 of the container. Its lower end 600 may, in the final mounted position, come to rest against the shoulder 26 of the container.

In the final mounted position, the side skirt 60 of the hoop may extend in the continuation of the side wall 20 of the container, and in particular of the cylinder 201. Thus, this skirt and this cylinder may have a transverse cross section of substantially identical shape and size, at least at this junction zone.

Secondly, the dispensing member 3 may be combined with the container 2. To do this, the body 30 of the dispensing member may be engaged through the mounting aperture 25 of the container. This member may be maintained by means of the fixing ring 32. Once in place, the body 30 may be axially fixed relative to the container.

The dispensing stem 31 may extend in a longitudinal axis Z parallel to or even coincident with the axis X of the aperture 25 of the container. Thus, this stem may be inclined relative to the axis of elongation Y of the container.

The push-button may then be combined with the product container fitted with the hoop 6 and the dispensing member 3.

The indexing means 210 may allow correct positioning of the container 2 relative to a mounting head of the push-button in the case of industrialized assemblage.

During such assemblage, the reinforcing ring 56 may be positioned through the cutaway 63 of the hoop. Such a cutaway then allows this ring 56 to access the dispensing member 3, and in particular the neck of the container. The ring 56 may then be firmly mounted on the mouth 24 of the container. More precisely, the means 560 for fixing the said ring 56 may click-fasten onto the mouth 24 of the container, and in particular onto the fixing ring 32. In the mounted position, the reinforcing ring 56 may come to bear, where appropriate radially, around the fixing ring 32 of the dispensing member 3. In other words, the fixing ring is placed between the reinforcing ring and the mouth.

In parallel, the tip 33 may be mounted on the dispensing member. In particular, the sleeve 34 of the tip may be fitted tightly around the dispensing stem 31. This tip may optionally be guided in movement, and in particular in translation, by the drum 561. The channel 35 is then in fluid communication with the said dispensing stem 31. The cap can, for its part, be firmly mounted on the hoop 6. To do this, the lower end 700 of the cap can be fitted around the neck 62. Other fixing means may be envisaged, such as click-fastening or crimping. Out of aesthetic concern, in the mounted position, the lower end 700 of the cap may come to rest against the shoulder 61 of the hoop.

In the mounted position of the push-button, the actuating member 55 is eccentric relative to the axis of elongation Y of the container. In other words, this member is offset relative to the container. This member may be offset outwards relative to the side wall 20 of the container. This member may extend on only one side of a plane passing through the axis of elongation Y of the container.

These actuating means 5 may extend exclusively in the upper part of the container 2. In particular, these actuating means may extend in only the upper half of the container 2. The actuating means may have a centre of inertia that is outside the container.

The toggle lever system may extend in an inclined general direction relative to the axis of elongation Y of the container.

According to one assembly variant, the push-button and the dispensing member 3 may form a unit assembly to be combined with the product container, and, where appropriate, with the hoop 6. Such an assembly mode is compatible, for example, with a dispensing member of the pump-stopper type, combined with the container without a fixing ring 32.

To actuate such a device, the user squeezes both sides of the seating 50 on the outer surfaces 550 of the plates 55. In the mounted position, these outer surfaces thus define manually movable actuating surfaces.

According to the invention, the user thus squeezes both sides of a plane containing the longitudinal axis Z of the dispensing stem 31.

This translational movement of the actuating surfaces towards each other places a load on the toggle lever system 52. This load is reflected by a movement of the force transmission arms constituting the toggle lever system, from a flexed resting state to an extended constrained state. Extension of this toggle lever by means of the various hinges moves the socket 530 in translation and consequently the dispensing stem 31 on which it is mounted.

When the dispensing stem is of the pump stem type, this stem may be moved translationally relative to the body 30. When the dispensing stem is of the valve stem type, this valve may be moved translationally or by pivoting relative to the body 30.

Assuming that the dispensing member has been primed beforehand, the movement in leaktight sliding contact of this dispensing stem 31 in the body 30 results in suction of the fluid product through this stem. The product then follows the channel 33, after which it enters the flexible tube 4. The product then arrives at the nozzle 74 and in particular at the nozzle cone 741 through which it is ejected in sprayed form.

When the actuating surfaces 550 are released, the toggle lever system may return to its resting state by virtue of return means. The toggle lever system may form return means for the actuating member. The inner surface 551 may optionally be covered with a compressible foam forming return means for the actuating member. To do this, this foam may, for example, be fixed by bonding.

Where appropriate, the metering chamber of the dispensing member becomes refilled due to the negative pressure created by the rising of the dispensing stem spurred by the return means. These return means may facilitate the return of the toggle lever system and of the actuating member to their resting state.

It should be noted that the seating 50 may comprise outer edges 58 provided with reliefs projecting outwards relative to the actuating surfaces 550, so as to prevent untimely movement of the actuating member and consequently accidental actuation of the device, for example when carrying the assembly in a handbag. These outer edges 58 form embellishments provided with reliefs projecting outwards relative to the actuating surfaces 550.

The plates 55 may be guided in motion relative to each other by the inner surface 511 of the seating 50. Other guide means may be used.

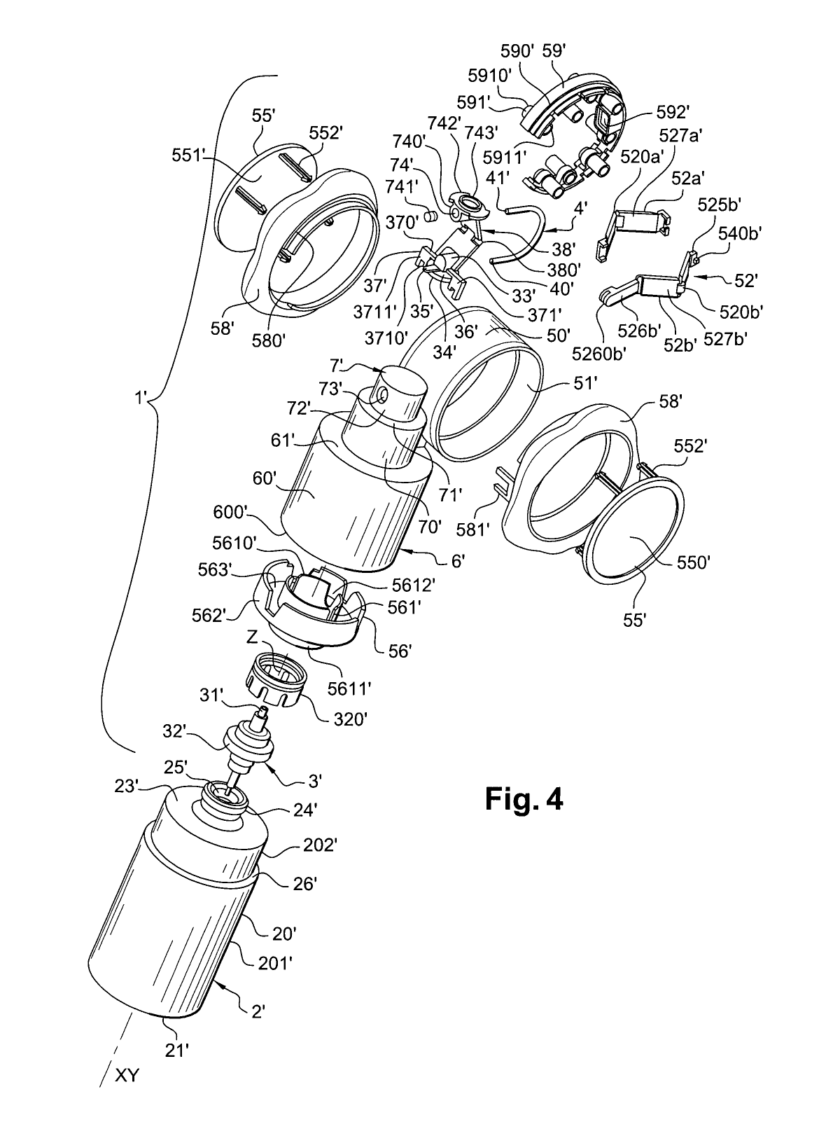

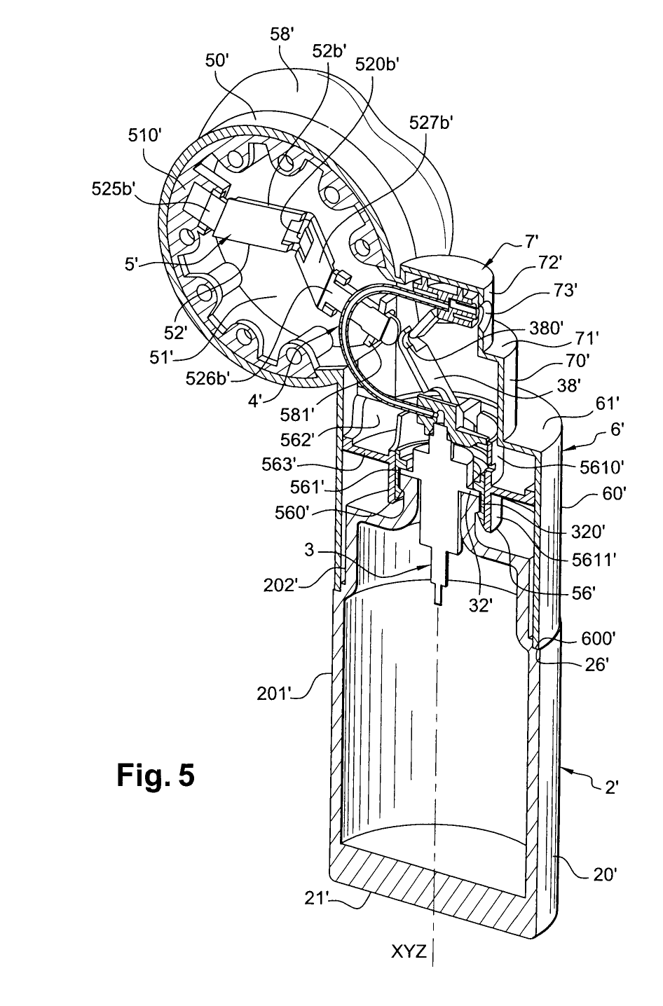

FIGS. 4 and 5 represent a second embodiment of an assembly 1′ for packaging and dispensing a product.

Only the elements of the second embodiment that differ from the elements of the first embodiment will be described. Similar references, supplemented with a prime sign, have been attributed to elements of the second embodiment that are similar to the elements of the first embodiment.

This second embodiment differs especially from the first embodiment of the push-button. In this embodiment, the mounting hoop 6′, the cap 70′ and the seating 50′ are made as one piece.

According to this embodiment example, the axis X of the mounting aperture 25′ may be parallel to or even coincident with the axis of elongation Y of the container.

According to this embodiment example, the reinforcing ring 56′ is not made as one piece with the seating 50′. Furthermore, it does not rise from the housing 51′ of the seating receiving the toggle lever system. In the present example, this reinforcing ring 56′ comprises a sleeve defining a drum 561′ provided with fixing means, and in particular click-fastening means, 560′. This ring also comprises an outer crown 562′. This drum and this crown may be joined together by a radial flange 563′. The crown 562′ may extend only upwards from the flange 563′. It may comprise a plurality of indentations so as to give it elastic character during its mounting in the hoop 6.

According to one variant, not shown, the crown 562′ may extend downwards for the purpose of mounting it around the container 2′. In particular, this crown may comprise a skirt designed to hold around the side wall 202′ of the container, and optionally to come to rest against the shoulder 26′ of the container 2′. This skirt may be provided with fixing means designed to co-operate with complementary fixing means provided on the inner surface of the side skirt 60′ of the hoop. For example, the crown skirt may comprise one or more slits designed to co-operate with reliefs made on the said side skirt of the hoop. This skirt may optionally be provided with an elastic inner bead. Such a reinforcing ring 56′ may serve as a compensator with regard to the manufacturing tolerances of the material of which the container is made, especially when this container is made of glass.

The reinforcing ring may comprise indexing means for the purpose of facilitating the mounting of the nozzle 74′ in the ejection head 72′. Guide means may also be provided.

The drum 561′ may extend on either side of this flange and may thus comprise a top section 5610′ and a bottom section 5611′. The top section 5610′ may comprise a plurality of circumferentially spaced slits, such as two diametrically opposite slits 5612′, the function of which will be explained later in the present description.

This top section 5610′ may optionally be configured to serve for holding the nozzle 74′ facing the window 73′ of the ejection head 72′. In other words, this top section might extend into the ejection head 72′ in the position mounted in the hoop 6′.

The bottom section 5611′ may receive a retaining ring 320′. This ring may be held in this section by any suitable means, such as by click-fastening.

The tip 33′ may comprise a sleeve 34′ for connecting to the dispensing stem 31′, which is in the form of a pellet. The channel 35′ rising from this sleeve may comprise a portion 350′ that extends axially in the axis Z of the dispensing stem and a portion 351′ that extends transversely to this axis.

This tip 33′ may also comprise a clamp 37′. This clamp may straddle this tip. Such a clamp may comprise a brace 370′ including on either side two uprights 371′.

The brace 370′ may extend from the portion 350′. More precisely, this brace may extend facing the inner recess 36′, or may even rest thereon.

The uprights 371′ may extend vertically in line with the brace 370′. They may be arranged overhanging the recess 36′. Such uprights may then extend radially outside this recess. They may comprise a free end 3710′ intended to be oriented towards the container 2. This free end may comprise a slit 3711′. The function of this clamp will be explained hereinbelow in the present description.

The nozzle 74′ may comprise a product ejection duct 740′ on which is mounted a plate 742′ for attachment to the ejection head 72′. This plate may comprise a circular rib 743′, the function of which will be explained later.

In the mounted position, the nozzle 74′ is held facing the window 73′ of the ejection head 72′. The rib 743′ may optionally co-operate with a corresponding groove in the ejection head 72′ (not shown) so as to ensure or reinforce this holding. As a variant, this nozzle may be firmly engaged in the window 73′.

The nozzle 74′ and the tip 33′ may be connected together via additional force transmission means 38′. These force transmission means may comprise a toggle lever.

This toggle lever 38′ may comprise an arm for connecting to the clamp 37′, and in particular to the brace 370′, and an arm for connecting to the nozzle 74′, and in particular to the plate 742′. These connecting arms may be articulated relative to each other by means of a hinge 380′, where appropriate in the form of a pin hinge or a film hinge. These connecting arms are articulated relative to the brace 370′ and to the plate 742′ by means of a respective hinge, where appropriate in pin hinge form.

The actuating means 5′ may comprise force transmission means 52′ comprising a toggle lever system comprising two toggle lever devices 52a′, 52b′ arranged facing each other. This device may comprise a toggle lever that is generally V-shaped.

Each device may comprise two force transmission arms 5527a′, 527b′ connected via a hinge 520a′, 520b′ defining an axis of rotation. The arm 527a′ may comprise two opposite free ends each provided with fixing means for securing it to the arm 527b′. These fixing means may comprise, for example, click-fastening hooks. As a variant, this toggle lever system may be made as one piece.

The device 52b′ may comprise an arm 525b′ for fixing to the seating 50′. This fixing arm may comprise fixing means 540b′. These fixing means may comprise a male connector designed to be firmly inserted in a female connector provided on the inner surface 511′ of the housing 51′ of the seating 50′, or on inner armoring 59′ as will be mentioned later in the present description. These fixing means may firmly anchor the force transmission means 52′ to the seating 50′ and thus form a fixed bearing point when a load is placed on the actuating means 5′.

The device 52b′ may also comprise a loading arm 526b′ comprising a free end 5260b′.

The fixing arm 525b′ and the loading arm 526b′ are rotatably articulated relative to the force transmission arms 527a′, 527b′.

The seating 50′ may comprise inner armoring 59′. This inner armoring may be firmly received in the housing 51′ by any suitable means, such as by click-fastening. To do this, the inner surface 511′ of the seating 50′ may comprise a cord 512′ that can engage in a groove 590′. This cord and this groove may, for example, be of circular profile.

This armoring may comprise a housing 592′ for receiving the arm 525b′ for fixing the force transmission means 52′. This housing may form a female connector capable of firmly receiving the male connector of the said arm as mentioned previously. As a variant, the free ends of an added hinge provided between the arms 525b′ and 527a′, 527b′ may be used to fix the toggle lever system into corresponding hollows of the housing 592′ (not shown).

This armoring 59′ may support means 591′ for guiding the actuating member 55′. These guides means may comprise one or more socket(s). These sockets may be right cylinders. These sockets may define on the inside a blind bore or, advantageously, a through-bore. Such sockets may be circumferentially distributed on the armoring 51′. These sockets may comprise an access aperture 5910′ oriented towards one or the other of the inner surfaces of the plates 55′. Where appropriate, this socket may comprise a retaining aperture 5911′, opposite the access aperture. Such sockets may be designed to receive complementary guides means 552′.

These complementary guide means 552′ may rise from the inner surface 551′ of the plates 55′. These complementary guide means may, for example, comprise spindles 552′ capable of being slidably received in the said bores. These spindles may comprise a free end forming a spear 5520′. Thus, once the spindles have been received in their access aperture 5910′, this spindle may pass through the corresponding socket and project relative to the retaining aperture, the spear 5520′ then being able to be held on the said retaining aperture 5911′. Thus, once in place, the plates 55′ will be able to be held in place in the seating 50′ and guided in translation via the co-operation of the sockets 591′ with the spindles 552′.

The seating 50′ may comprise a transverse aperture 564′ intended to receive the loading arm 526b′ and optionally a separate aperture 565′ for passing through the flexible tube 4′. The aperture 565′ may be in communication with the passage 75′ of the ejection head.

The seating 50′ may comprise added outer edges 58′. These outer edges may be in the form of embellishments added on either side of the seating 50′. Such embellishments may be combined by any suitable means 580′ with the seating 50′, in particular by click-fastening, screwing or tight fitting.

As a variant, these embellishments may be mounted on the armoring 59′, such as by click-fastening.

At least one of these embellishments may comprise a guide member 581′ for the loading arm 526b′ when the latter moves in translation. This member 581′ may comprise a fork that can receive this arm 526b′ between two teeth.

This member may extend on either side of the aperture 564′, or even at least partly facing this aperture. As a variant, the aperture 564 may per se act as a guide means for the movement of the loading arm 526b′.

As a variant or additionally, the armoring 59′ may form such guide means for the loading arm 526b′.

The assemblage of such a dispensing assembly according to this second embodiment may especially be obtained in the following manner.

Firstly, the dispensing member 3′ may be combined with the container 2′ by means of the fixing ring 32′.

In this embodiment example, the dispensing stem 31′ extends in a longitudinal axis Z parallel to or even coincident with the axis X of the aperture 25′ of the container. This stem may also extend in an axis parallel to or even coincident with the axis of elongation Y of the container.

The first end 40′ of the flexible tube may be connected to the channel 35′ of the tip 33′. This tip may be mounted on the reinforcing ring 56′. To do this, the uprights 371′ of the clamp may be mounted through their respective slit 5612′. These uprights may come to rest against the bottom of these slits. Fixing means may be provided to hold these uprights in position. In particular, the slits 5711′ may be guided in the slits 5612′.

This assembly is then positioned through the hoop 6′ for the purpose of fixing the nozzle 74′ into the ejection head 72′. In order to hold this assembly in position in the hoop, this hoop may optionally comprise on the inside click-fastening means, such as a bead, which can be elastically passed by the outer crown 562′ of the reinforcing ring.

The nozzle 74′ may then be mounted in the ejection head 72′. To do this, the nozzle may be mounted through the aperture 700′ of the cap. The circular rib 743′ may be designed to bear axially against the ejection head 72′, as may be seen in FIG. 5. This rib may serve to position the nozzle 74′ opposite the window 73′, and optionally to attach the plate 742′ to the ejection head.

The nozzle 74′, and in particular the nozzle cone 741′ combined therewith, may be firmly received through the window 73′ of this ejection head. The second end 41′ of the flexible tube may then be connected to this nozzle 74′, especially by positioning through the passage 75′. As a variant, this second end of the tube may be combined with the nozzle 74′ before assembling this nozzle in the ejection head 72′ and even before mounting through the hoop 6′.

The actuating means 5′ may be incorporated. To do this, the toggle lever devices 52a′, 52b′ are, in this example, first combined together. The fixing arm 525b′ is then firmly mounted in the housing 592′ of the inner armoring 59′. This armoring may then be firmly positioned in the housing 51′ of the seating. The embellishments 58′ may then be mounted on either side of this housing 51′. Finally, the plates 55′ may be mounted through the embellishments 58′. The spindles 552′ may then be received through the sockets 591′. Such plates are thus mounted translationally mobile in the said housing 51′.

According to one assemblage variant, the embellishments 58′ may be first combined with the seating, then the plates 55′ added therethrough.

In this embodiment example, the force transmission means 52′, 38′ thus comprise a plurality of toggle lever systems arranged in series. Such toggle lever systems may thus be actuated consecutively. The actuation of one may act on the actuation of the other for the purpose of moving the dispensing stem 31′ relative to the body 30′ in which it is engaged.

The toggle lever systems 52′ and 38′ may extend and in particular may be deployed in a distinct general direction.

The toggle lever system 52′ may be deployed in a general direction different from the axis of elongation Y of the container. This system may be deployed in a general direction different from the longitudinal axis Z of the dispensing stem 31′.

The toggle lever system 52′ may be deployed in a general direction parallel to or even coincident with the axis of elongation Y of the container. This system may be deployed in a general direction parallel to or even coincident with the longitudinal axis Z of the dispensing stem 31′.

In the deployed state, these toggle lever systems may define an angle of less than 90°, such as 60°, 45°, 30° or 15°, or even virtually zero.

The push-button comprising in this example the actuating means 5′, the tip 33′, the cap 7′, optionally equipped with the nozzle 74′, and the hoop 6′, may then be mounted on the container 2′.

To do this, the retaining ring 320′ housed in the reinforcing ring 56′ may be mounted around the fixing ring 32′, especially by click-fastening. The tip 33′ may, itself, be connected to the dispensing stem so as to establish a fluid communication.

According to one assembly variant, the push-button and the dispensing member 3 may form a unit assembly to be combined with the product container, especially when the dispensing member is of the pump-stopper type.

To actuate such a device, the user squeezes both sides of the seating 50 on the outer surfaces 550′ of the plates 55.

This actuation moves the toggle lever system 52′ from a flexed resting state to an extended constrained state. The loading arm 526b′ is then moved in translation. This arm 526b′ may be guided in translation through the guide member 581′. The free end 5260b′ may then come to bear on the hinge 380′ of the toggle lever 38′ for the purpose of moving it from a flexed resting state to an extended resting state. This extension of the toggle lever 38′ then results in a movement of the dispensing stem 31′ relative to the body 30′, enabling the dispensing of product contained in the container 2′.

According to another variant, not shown, the mounting hoop and the cap may be made as one piece, and the seating added to this assembly. According to another variant, not shown, the cap and the seating may be made as one piece and added to the hoop.

Throughout the description, the expressions “comprising one” and “including one” should be considered as being synonymous with “comprising at least one” and “including at least one”, unless otherwise specified.

Obviously, numerous modifications and variations of the present invention are possible in light of the above teachings. It is therefore to be understood that within the scope of the appended claims, the invention may be practiced otherwise than as specifically described therein.

1. A device for dispensing a cosmetic product, comprising:
a product dispensing member including a dispensing stem of longitudinal axis Z movably mounted in a body configured to be engaged through an aperture of a container;
means for actuating the dispensing member, which can move the dispensing stem relative to the body;
a dispensing orifice that dispenses product onto a body surface; and
a flexible product ejection tube connecting the dispensing stem to the dispensing orifice,
wherein the actuating means are configured to be actuated by squeezing both sides of a plane containing the longitudinal axis Z of the dispensing stem.

2. The device according to claim 1, wherein the actuating means include a seating to be firmly mounted onto a container having two mutually mobile actuating surfaces.

3. The device according to claim 2, wherein the seating includes two opposite apertures closed off by a respective plate each defining an actuating surface.

4. The device according to claim 2, wherein the actuating surfaces are guided in movement relative to the said seating.

5. The device according to claim 2, wherein the actuating surfaces are mutually translationally mobile relative to the seating.

6. The device according to claim 1, wherein the actuating means include at least one toggle lever system.

7. The device according to claim 1, wherein the actuating means include two toggle lever systems arranged in series.

8. The device according to claim 7, wherein the two toggle lever systems extend in the extended position in two different general directions.

9. The device according to claim 8, wherein the two toggle lever systems are deployed, respectively, in an inclined general direction relative to the dispensing stem and in a general direction substantially parallel to or coincident with the longitudinal axis of the dispensing stem.

10. The device according to claim 1, wherein a load is placed on the actuating means in an actuating direction different from the direction of movement of the dispensing stem.

11. The device according to claim 1, wherein a load is placed on the actuating means in an actuating direction substantially perpendicular to the direction of movement of the stem.

12. An assembly for packaging and dispensing a cosmetic product, comprising:
a device according to claim 1, combined with a container configured to contain a reserve of cosmetic product.

13. The assembly according to claim 12, wherein the actuating means include at least one toggle lever system extending in an inclined general direction relative to an axis of elongation of the container.

14. The assembly according to claim 12, further comprising:
a seating mounted outside the container, eccentrically relative to an axis of elongation of the container.

15. The assembly according to claim 12, wherein the seating is firmly oriented relative to the container.

16. The device according to claim 3, wherein the actuating surfaces are guided in movement relative to the said seating.

17. The assembly according to claim 13, further comprising:
a seating mounted outside the container, eccentrically relative to the axis of elongation of the container.

18. The assembly according to claim 13, wherein the seating is firmly oriented relative to the container.
